(19) United States
(12) Patent Application Publication
(10) Pub. No.: US 2023/0321739 A1
(43) Pub. Date: Oct. 12, 2023

(54) THREAD CLEANING METHOD AND APPARATUS

(71) Applicant: RIMWEST PTY LTD, Malaga (AU)

(72) Inventor: Scott WILLIAMS, Malaga (AU)

(21) Appl. No.: 18/188,113

(22) Filed: Mar. 22, 2023

Related U.S. Application Data
(63) Continuation-in-part of application No. PCT/AU2021/051108, filed on Sep. 22, 2021.

(30) Foreign Application Priority Data
Sep. 22, 2020 (AU) 2020903396
Jul. 8, 2021 (PH) 12021050307

(51) Int. Cl. B23G 9/00

(52) U.S. Cl. CPC B23G 9/009

(57) ABSTRACT

An apparatus and method for cleaning a threaded section having a first thread adapted to receive a counterpart threaded section having a second thread, the apparatus comprising a source of rotational movement, rotational means for operatively connecting either the threaded section or the counterpart threaded section or the threaded section to the source of rotational movement, and fixing means for fixing either (1) the counterpart threaded section to impede rotational movement the counterpart threaded section when the threaded section is operatively connected to the source of rotational movement or (2) the threaded section to impede rotational movement the threaded section when the counterpart threaded section is operatively connected to the source of rotational movement.

### RELATED APPLICATIONS

The present application is a continuation-in-part of PCT Application No. PCT/AU2021/051108 filed on Sep. 22, 2021, which claims priority to Australian Application No. 2020903396 filed on Sep. 22, 2020, and Philippine Application No. 12021050307 filed on Jul. 8, 2021, the entirety of the foregoing applications being incorporated herein by reference.

### TECHNICAL FIELD

The present invention relates to methods and systems for cleaning equipment and parts thereof.

The invention has been devised particularly, although not necessarily solely, in relation to cleaning grooves of equipment and fastening means including threads.

### BACKGROUND ART

The following discussion of the background art is intended to facilitate an understanding of the present invention only. The discussion is not an acknowledgement or admission that any of the material referred to is or was part of the common general knowledge as at the priority date of the application.

Scaffolding systems are temporary structures used to support a work crew and materials to aid in the construction, maintenance and repair of buildings, bridges and all other man-made structures. For example, scaffolding structures may surround building structures to apply render and paint onto the exterior surfaces of buildings.

The fact that the scaffolding systems are adjacent building constructions to which render and paint is applied results in that most of the parts of the scaffolding systems will be covered, after applying the render and paint, with render and paint residue, which will harden as time goes by and become firmly attached to the parts of the scaffolding systems.

Upon completion of the render and paint job, the scaffolding system is dismounted and shipped back to, for example, the owner of the scaffolding system that may have hired-out the scaffolding system.

At the owner's premises, all parts of the scaffolding system require a throw-out cleaning to remove any render and paint debris that may be firmly attached to the scaffolding parts.

Typically, the cleaning process is difficult and cumbersome and time consuming, thus expensive. This is particularly true in the instances that the jacks of the scaffolding systems need to be cleaned.

As shown in FIG. 1, the jacks 1 of the scaffolding system comprise threaded pole 2 extending perpendicularly from a base plate 3 for supporting the jack 1 while mounted on the ground. The jack 1 also comprises a screw nut 4 screwed on the threaded pole 2.

FIG. 1 shows a conventional jack 1 with the threaded section 5 of the pole 2 mostly covered with render and/or paint debris. As shown, the debris is firmly attached to the threaded section 5; and, in particular debris has become stuck within the grooves formed between the crests of the thread of the pole 2.

Removal of the hardened debris from the jack 1 and in particular extraction of the debris from within the grooves formed between the crests of the thread is a massive time-consuming task.

It is against this background that the present invention has been developed.

### SUMMARY OF INVENTION

According to a first broad aspect of the invention there is provided a method for cleaning a threaded section having a first thread adapted to receive a counterpart threaded section having a second thread, the method comprising the steps of:
fixing either (1) the counterpart threaded section to impede rotational movement of the counterpart threaded section when the threaded section is operatively connected to the source of rotational movement or (2) the threaded section to impede rotational movement of the threaded section when the counterpart threaded section is operatively connected to the source of rotational movement;
operatively connecting either the threaded section or the counterpart threaded section to a source of rotational movement when the threaded section and the counterpart threaded section are threated onto each other; and
activating the source of rotational movement for rotating either the threaded section or the counterpart threaded section for displacing either the counterpart threaded section or the threaded section towards a particular direction.

Preferably, the crest of the rotating thread is moved within the grooves of the stationary thread to remove any debris from the first thread and/or second thread.

Preferably, the crest of the rotating thread is moved within the grooves of the stationary thread to loosen the threaded section and the counterpart threaded section with respect to each other.

Preferably, the method further comprises the step of selectively displacing either the counterpart threaded section or the threaded section towards a first direction and a second direction.

Preferably, the method further comprises the step of recurrently activating the source of rotational movement for providing rotational movement to the counterpart threaded section or the threaded section in the clockwise direction and recurrently activating the source of rotational movement for providing rotational movement to the counterpart threaded section or the threaded section in the counterclockwise direction.

Preferably, the threaded section is part of a scaffolding jack.

Preferably, the counterpart threaded section comprises a screw nut of the scaffolding jack.

According to a second broad aspect of the invention there is provided an apparatus for cleaning a threaded section having a first thread adapted to receive a counterpart threaded section having a second thread, the apparatus comprising a source of rotational movement, rotational means for operatively connecting either the threaded section or the counterpart threaded section to the source of rotational movement, and fixing means for fixing either (1) the counterpart threaded section to impede rotational movement of the counterpart threaded section when the threaded section is operatively connected to the source of rotational movement or (2) the threaded section to impede rotational movement of the threaded section when the counterpart threaded section is operatively connected to the source of rotational movement.

Preferably, the rotational means is adapted to either provide clockwise rotational movement or counterclockwise rotational movement to either the threaded section or the counterpart threaded section.

Preferably, the rotational means is adapted to be selectively displaced between an operative condition for operatively attaching either the threaded section or the counterpart threaded section, and a non-operative condition for detachment of either the threaded section or the counterpart threaded section.

Preferably, the rotational means comprises a coupling adapted to releasably attach an end of the threaded section or at least a portion of the counterpart section.

Preferably, the fixing means comprises a frame and a fixing assembly attached to the frame, the fixing assembly being adapted to receive either the threaded section or the counterpart threaded section to impede rotational movement of either the threaded section or the counterpart threaded section.

Preferably, the coupling comprises a spin housing being adapted to releasably attach an end of the threaded section or at least a portion of the counterpart threaded section.

Preferably, the coupling further comprises a cage for receiving the spin housing.

Preferably, the spin housing comprises an electric motor having a shaft, and a spin section rotatably attached to the shaft.

Preferably, the spin section comprises a coupling with a cavity, the coupling being attached to the shaft to transfer the rotational force generated by the electric motor to the coupling.

Preferably, the coupling is configured for receiving an end of either the threaded section or at least a portion of the counterpart threaded section.

Preferably, the cavity is configured to match the outer profile of either the threaded section or the counterpart threaded section such that upon rotation of the spin section, the threaded section or the counterpart threaded section rotates with the spin section.

Preferably, the cage containing the spin housing comprises handles extending from sides of the cage permitting operators to manipulate the cage.

Preferably, at least one of the handles is operatively connected to an electric controller of an electric system delivering electric power to the electric motor for driving of the spin housing.

Preferably, the rotational means is adapted to be displaced between an upper position and a lower position.

Preferably, the apparatus further comprises a post attached to the fixing means and a travel frame set slideably attached to the post, the travel frame set being adapted for attachment of the rotational means thereto.

Preferably, the apparatus further comprises a counterweight system having a counterweight, a pulley assembly and a cord supported by the pulley assembly, the rotational means being operatively connected to the counterweight system via the cord.

Preferably, the threaded section is part of a pole rod of a scaffolding jack having a base plate, and the counterpart threaded section comprises a screw nut of the scaffolding jack.

Preferably, the cavity is configured in order to operatively connect either the base plate or the screw nut to the coupling.

Preferably, the fixing assembly comprises a plurality of rods that extend from a lower portion of the frame towards an upper location of the frame.

Preferably, the plurality of rods are arranged in a spaced apart relationship with respect to each other defining a plurality of spacing between neighbouring rods.

Preferably, the spacing is adapted to receive wings of the screw nut, or the base plate for keeping the screw nut or the base plate in a non-rotational condition.

Preferably, the fixing assembly comprises a hollow centre rod for receiving the end of the pole rod.

Preferably, the fixing means for keeping the screw nut in a non-rotational condition comprises a table desk for mounting on the frame, the table desk comprising a surface having a slot for receiving the scaffolding jack in an inverted condition.

Preferably, the surface comprises a mesh surface.

According to a first aspect of the invention there is provided a method for cleaning a threaded section having a thread groove adapted to receive a screw nut having an internal thread, the method comprising the steps of:
a. operatively connecting the threaded section to a source of rotational movement when the threaded section and the screw nut are threated onto each other;
b. fixing the screw nut such as to impede rotational movement of the screw nut and allowing movement of the screw nut along the threaded section when the threaded section is operatively connected to the source of rotational movement; and
c. activating the source of rotational movement for rotating the threaded section for displacing the screw nut towards a particular direction along the threaded section.

Preferably, the method further comprises the step of recurrently activating the source of rotational movement for providing rotational movement to the threaded section in the clockwise direction and recurrently activating the source of rotational movement for providing rotational movement to the threaded section in the counterclockwise direction for selectively displacing the screw nut towards a first direction and a second direction opposite to the first direction.

Preferably, the threaded section is part of a scaffolding jack.

Preferably, the screw nut comprises a screw nut of the scaffolding jack.

According to a second aspect of the invention there is provided an apparatus for cleaning a threaded section having thread grooves adapted to receive a screw nut having an internal thread, the apparatus comprising a source of rotational movement, rotational means for operatively connecting the threaded section to the source of rotational movement, and fixing means for fixing the screw nut such as to impede rotational movement of the screw nut and allow movement of the screw nut along the threated section when the threaded section is operatively connected to the source of rotational movement.

Preferably, the rotational means is adapted to either provide clockwise rotational movement or counterclockwise rotational movement to the threaded section to move the screw nut along the threated section in a first direction or a second direction opposite to the first direction.

Preferably, the rotational means comprises a coupling adapted to releasably attach an end of the threaded section or at least a portion of the counterpart section.

Preferably, the fixing means comprises a frame and a fixing assembly attached to the frame, the fixing assembly being adapted to receive the screw nut to impede rotational movement of the screw nut and allow movement of the screw nut along the threaded section.

Preferably, a spin housing comprises the coupling being adapted to releasably attach the end of the threaded section.

Preferably, the rotational means comprises a cage for receiving the spin housing.

Preferably, the cage comprises handles extending from sides of the cage permitting operators to manipulate the cage.

Preferably, the spin housing comprises an electric motor having a shaft, and a spin section rotatably attached to the shaft.

Preferably, the spin section comprises a coupling with a cavity, the coupling being attached to the shaft to transfer rotational force generated by the electric motor to the coupling.

Preferably, the cavity is configured to match the outer profile of the end of the threaded section such that upon rotation of the spin section, the threaded section rotates with the spin section.

Preferably, at least one of the handles is operatively connected to an electric controller of an electric system delivering electric power to the electric motor for driving of the spin housing.

Preferably, the rotational means is adapted to be displaced between an upper position and a lower position.

Preferably, the apparatus further comprises a post attached to the fixing means and a travel frame set slideably attached to the post, the travel frame set being adapted to receive the rotational means.

Preferably, the apparatus further comprises a counterweight system having a counterweight, a pulley assembly and a cord supported by the pulley assembly, the rotational means being operatively connected to the counterweight system via the cord.

Preferably, the threaded section is part of a pole rod of a scaffolding jack having a base plate, and the screw nut comprises a screw nut of the scaffolding jack.

Preferably, the cavity is configured in order to operatively connect the base plate to the rotational means.

Preferably, the fixing means comprises a plurality of rods that extend from a lower portion of the frame towards an upper location of the frame, wherein the rods are arranged in a spaced apart relationship with respect to each other defining neighbouring rods and a plurality of spacing between the neighbouring rods.

Preferably, the spacing is adapted to receive wings of the screw nut for keeping the screw nut in a non-rotational condition and allow movement of the screw nut along the threated section.

Preferably, the fixing assembly comprises a hollow centre rod for receiving the end of the pole rod.

Preferably, the apparatus further comprises a table desk for mounting on the frame, the table desk comprising a surface having a slot for receiving the scaffolding jack in an inverted condition.

Preferably, the surface comprises a mesh surface.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 shows front view of a conventional scaffolding jack requiring cleaning;

FIG. 2 shows the conventional scaffolding jack shown in FIG. 1 after cleaning using the method in accordance with a particular arrangement of a method in accordance with the present embodiment of the invention using a particular arrangement of an apparatus in accordance with the present embodiment of the invention;

FIG. 3 shows a perspective view of a particular arrangement of the apparatus shown in FIG. 1;

FIG. 4 shows a top perspective view of a particular arrangement of the table frame of the apparatus shown in FIG. 3;

FIG. 5 shows a top perspective view of the table desk of the apparatus shown in FIG. 3;

FIG. 6 shows a top perspective view of the driving means the apparatus shown in FIG. 3;

FIGS. 7 and 8 are, respectively, top and bottoms perspective views of the spin housing of the apparatus shown in FIG. 3;

FIG. 9 shows a top perspective view of the travel frame set of the apparatus shown in FIG. 3;

FIG. 10 shows a top perspective view of the counterweight weight of the apparatus shown in FIG. 3;

FIG. 11 shows a top perspective view of the counterweight cage of the apparatus shown in FIG. 3;

FIGS. 12 to 18 illustrate a particular arrangement of an apparatus in accordance with the present embodiment of the invention in use for conducting a particular arrangement of a method for cleaning a thread of a scaffolding jack.

### DESCRIPTION OF EMBODIMENT(S)

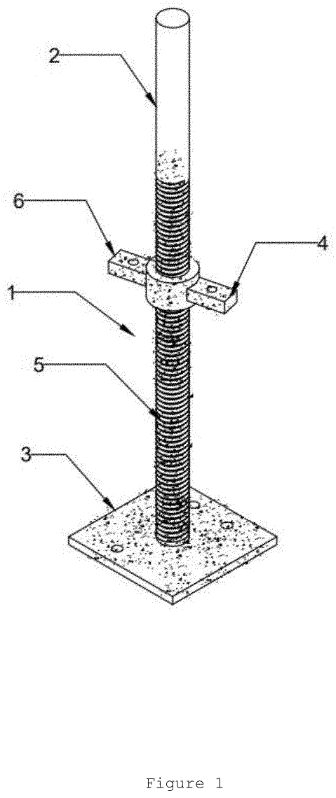

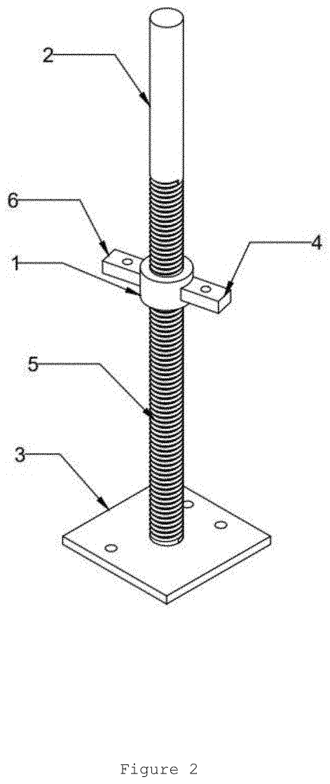

FIG. 1 shows a scaffolding jack 1 prior cleaning and FIG. 2 shows the scaffolding jack 1 after cleaning using the method and apparatus in accordance with the present embodiment of the invention.

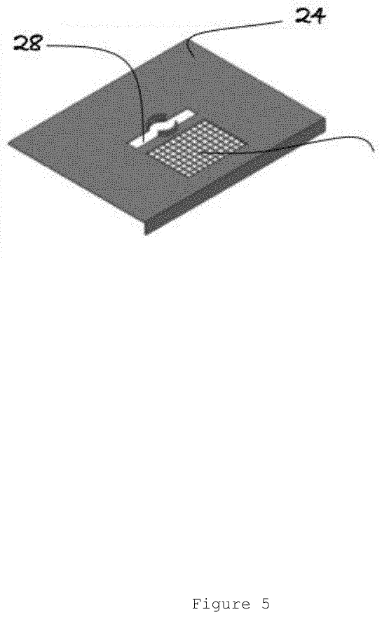

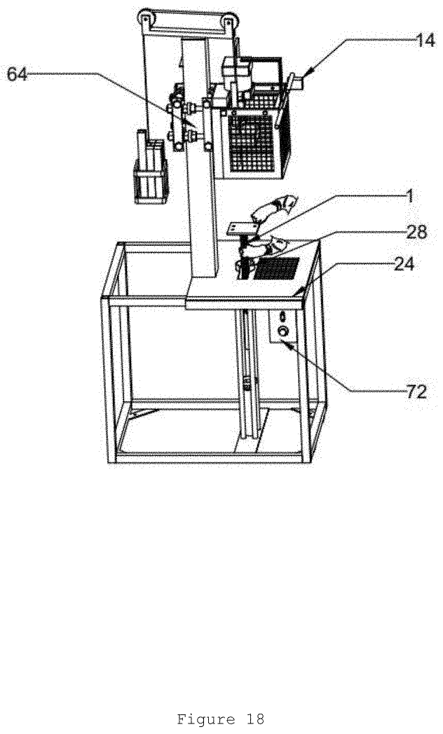

FIGS. 2 to 18 illustrate the apparatus 10 and the method conducted by the apparatus 10 for cleaning threaded sections 5 of, for example, scaffolding jack 1 in accordance with particular arrangements in accordance with the present embodiment of the invention.

As will be described with reference to the method of operation of the apparatus 10, threated sections 5 of equipment, such as for example, scaffolding jacks 1 shown in FIGS. 1 and 2 may be cleaned using the apparatus 10.

In accordance with a particular arrangement of the present embodiment of the invention, a threaded section comprising debris attached to the thread is cleaned using a nut adapted to be screwed onto the treaded section. In particular, the nut is screwed onto the threaded section and then via rotational movement of either the screw nut or the threaded section, any debris attached to the threaded section and in particular located within the thread grooves of the threaded section are removed from the threaded section. In particular, removal of the debris within the grooves of the threaded section is accomplished due to the action of the crests of the internal thread of the nut while the nut moves along the threaded section.

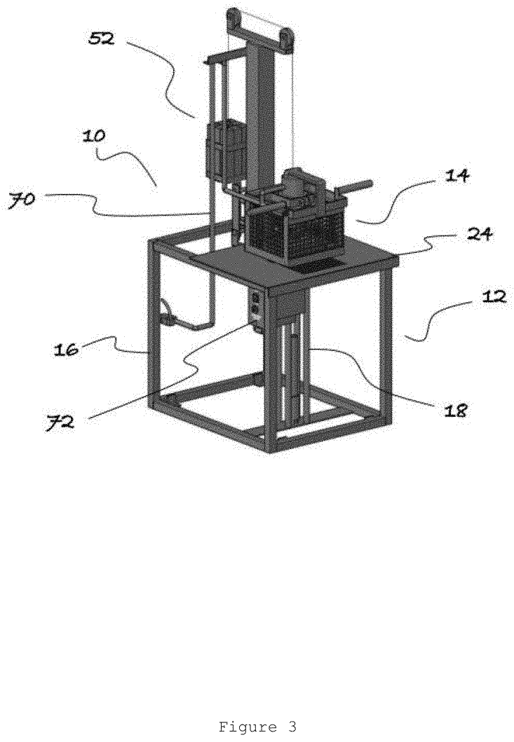

FIG. 3 shows a particular arrangement of an apparatus 10 in accordance with the present embodiment of the invention.

The apparatus 10 shown in FIG. 3 comprises means 18 for keeping the screw nut 4 in a non-rotational condition and means 14 for rotating the pole rod 2 comprising the threaded section 5. As will be described with reference to the method of operation of the apparatus 10 as shown in FIG. 3, by rotating the pole rod 2 (while maintaining the screw nut 4 in a non-rotational condition) the threaded section 5 may be cleaned through removal of any debris attached to the threaded section 5 due to the screw nut 4 (while the pole rod 2 is rotating) moving along the threaded section 5.

The means 12 for keeping the screw nut 4 in a non-rotational condition comprises a frame 16 and a fixing assembly 18 attached to the frame 16. The fixing assembly 18 is adapted to receive the screw nut 4 in order to fix the screw nut 4 in a non-rotational condition.

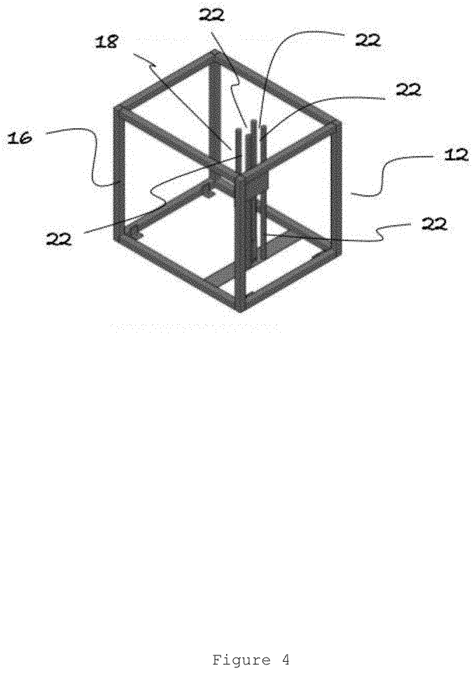

As shown in FIG. 4, the particular arrangement of fixing assembly 18 comprises a plurality of rods 20 that extend from a lower portion of the frame 16 towards an upper location of the frame 16 located below the means for rotating the pole rod 2 as shown in FIG. 3; in this manner, the pole rod 2 of the scaffolding jack 1 (attached to the means 12 for rotating) may be received with the fixing assembly 18.

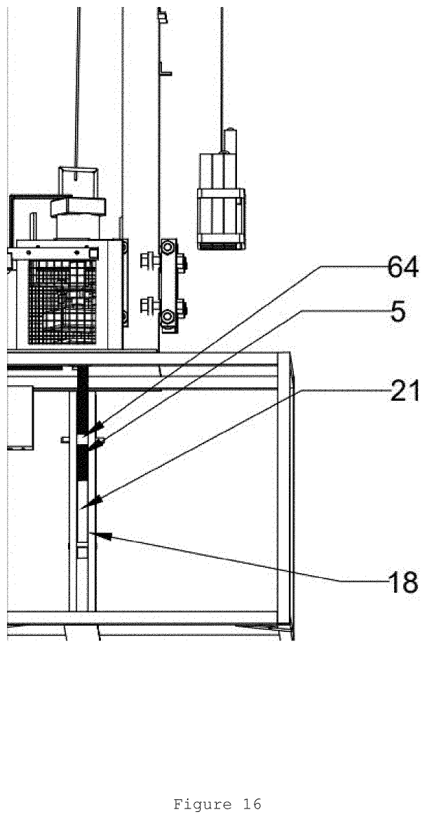

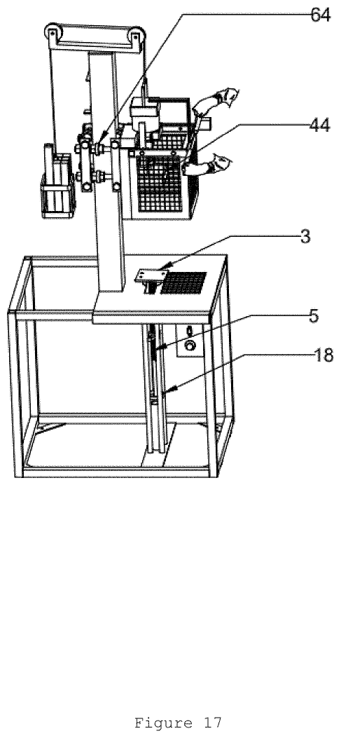

The plurality of rods 20 of the fixing assembly 18 are arranged in a spaced apart relationship with respect to each other defining a plurality of spacing 22 between neighbouring rods 20. The spacing 22 allows receiving the wings 6 of the screw nut 4, which results in that the screw nut 4 is kept in a non-rotational condition because the wings 6 are located between neighbouring rods 20 as shown, for example, in FIGS. 16 and 17. Thus, movement of the wings 6 is hindered due to the rods 20; this impedes rotation of the screw nut 4.

Further, the fixing assembly 18 comprises alignment means. In particular, the fixing assembly 18 comprises a hollow centre rod 21 (best seen in FIG. 16) for receiving the end of the pole rod 2. The fact that the end of the pole rod 2 is inserted in the hollow centre rod 21, ensures proper alignment of the pole rod 2 avoiding any undesired precessional movement of the pole rod 2 during rotation of the threaded section 5 due to impeding changes in the orientation of the rotational axis during rotation the pole rod 2.

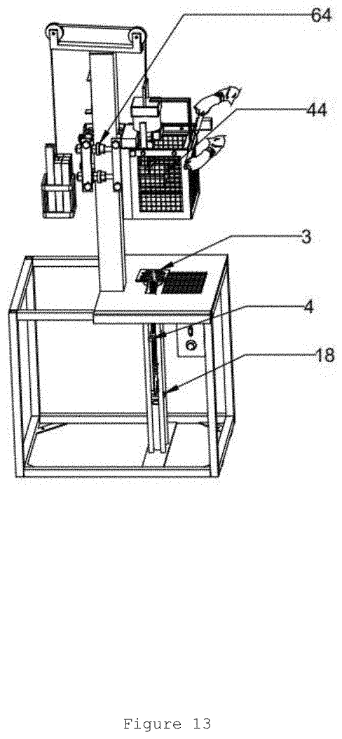

Furthermore, the means 12 for keeping the screw nut 4 in a non-rotational condition also comprise a table desk 24 for mounting on the frame 16 as is shown in FIG. 13.

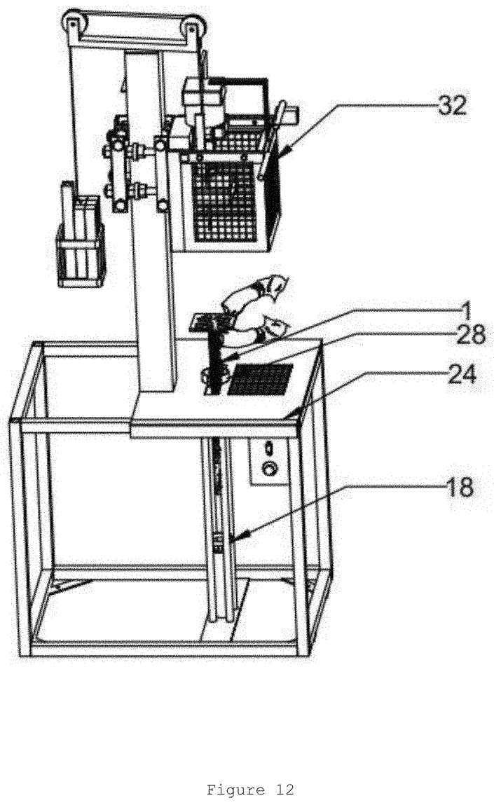

The table desk 24 comprises a surface 26 having a slot 28 for receiving the scaffolding jack 1 in an inverted condition (as shown in FIGS. 12 and 13), and a window 30 comprising a mesh structure. The slot 28 permits the scaffolding jack 1 to hang from the table desk 24 (see FIG. 13) in order to locate the pole rod 2 within the fixing assembly 18 such that the wings 6 of the screw nut 4 are located between neighbouring rods 20.

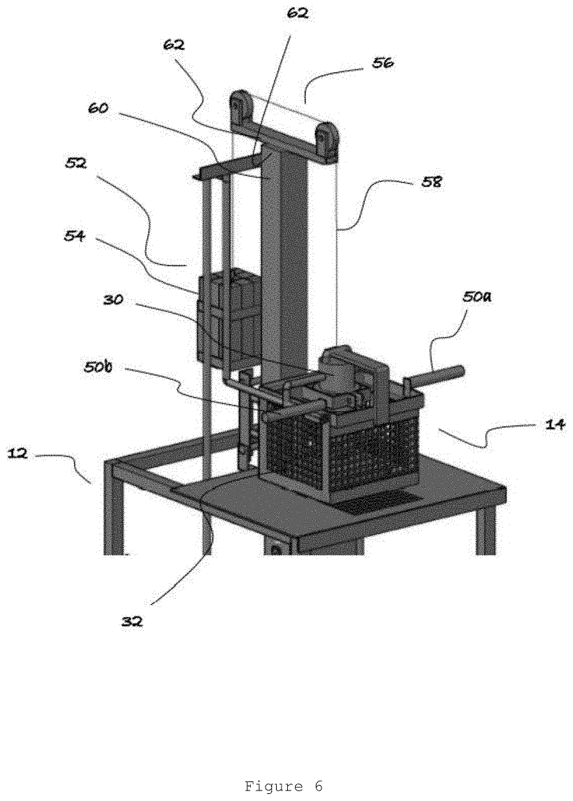

Referring now to FIG. 6, FIG. 6 shows the rotational means 14 for rotating the threaded section 5 for cleaning purposes.

As shown in FIG. 6, the rotational means 14 comprises a spin housing 30 and a cage 32 for at least partial containment of the spin housing 30. The cage 32 protects the operators of the apparatus 10 from any flying objects that may be ejected from the spin housing 30 during rotation of the threaded section 5. The cage 32 also comprises meshed side walls permitting viewing of the interior of the cage 32.

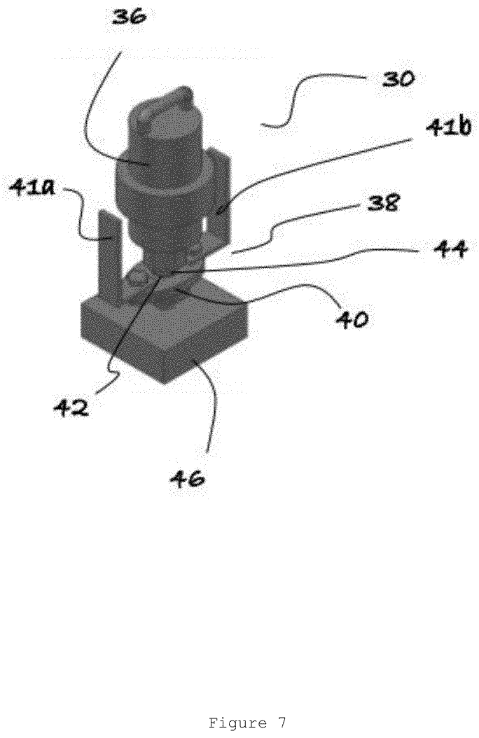

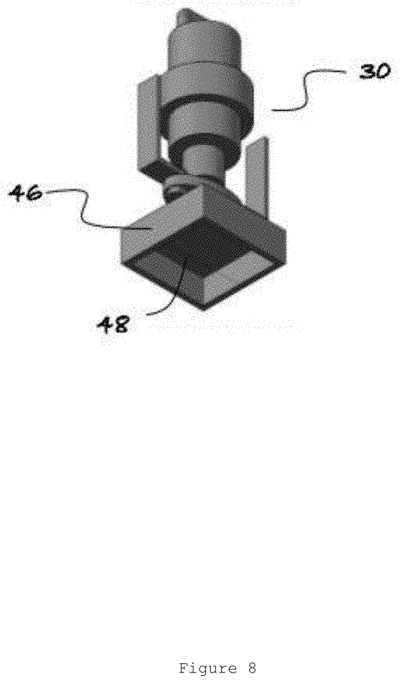

Further, FIGS. 7 and 8 show a particular arrangement of a spin housing 30. The spin housing 30 comprises an electric motor 36 and a spin section 38 rotatably attached to the electric motor 36. The spin section 38 comprises a centre piece 40 onto which side plates 41a and 41b are attached as shown in FIGS. 7 and 8. The centre piece 40 comprises an opening 42 to permit passage of the rotating shaft 44 rotatably attached to the electric motor 36. The side plates 41 are adapted for attachment to the sides of the cage 32 for securing the spin housing 30 within the cage 32.

Furthermore, the spin section 30 comprises a coupling 46 attached to the shaft 44 to transfer the rotational force generated by the electric motor 36 to the coupling 44.

The coupling 46 is adapted to be operatively connect the threaded section 5 to the coupling 46 to transfer the rotational force to the threaded section 5. In particular, the coupling 46 is configured for receiving an end of the threaded section 5.

In the particular arrangement in accordance with the present embodiment of the invention, the coupling 46 comprises a cavity 48 for receiving the base plate 3 of the scaffolding jack 1. The cavity 48 is configured in order to operatively connect the base plate 3 to the coupling 44. As shown in FIG. 8, the cavity 48 comprise a square opening indenting into the coupling 46 to receive the base plate 3 being configured as a square plate as shown in FIGS. 1 and 2. In alternative arrangements, the cavity 48 may be configured in any shape and manner in order to releasably attach any type of end onto which the threaded section 5 is attached.

Referring back to FIG. 6, the cage 32 comprises handles 50a and 50b extending from the sides of the cage 32 permitting the operators to manipulate the cage 32 during operation of the apparatus 10. At least one of the handles 50 is operatively connected to an electric controller of the electric system delivering electric power to the spin housing 30 for rotation of the threaded section 5 of the scaffolding jack 1.

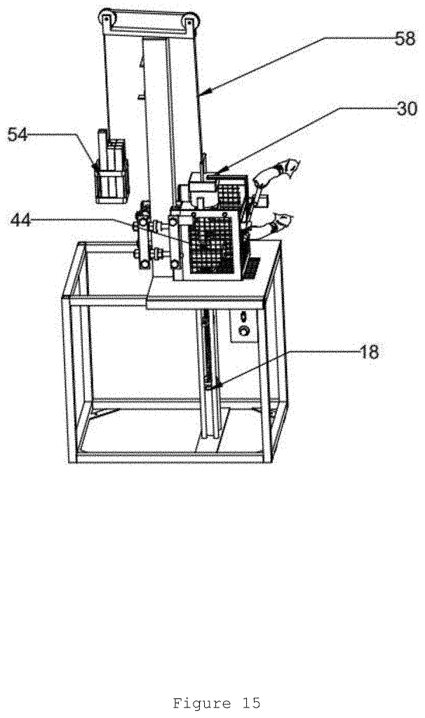

As mentioned above, the handles 50 allow manipulation of the cage 32 containing the spin housing 30. In particular, the operator while holding handles 50 with her/his hand may selectively displace the cage between a non-operative condition (see FIG. 12) and an operative condition (see, for example, FIG. 15).

Further, in accordance with the particular arrangement shown in the figures, the cage 32 is adapted to be displaced between an upper position (being a non-operative condition) and a lower position (being the operative condition).

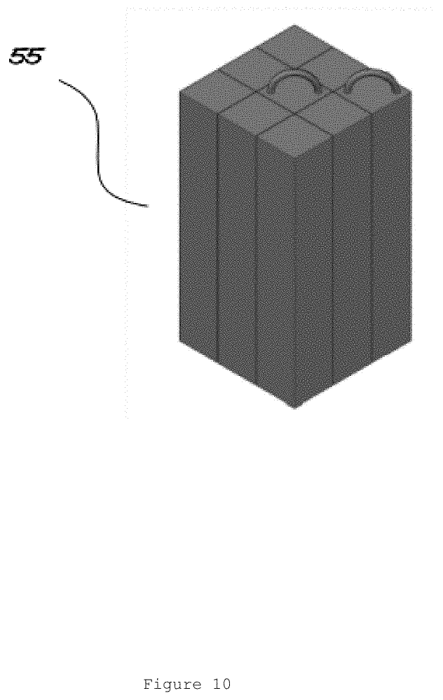

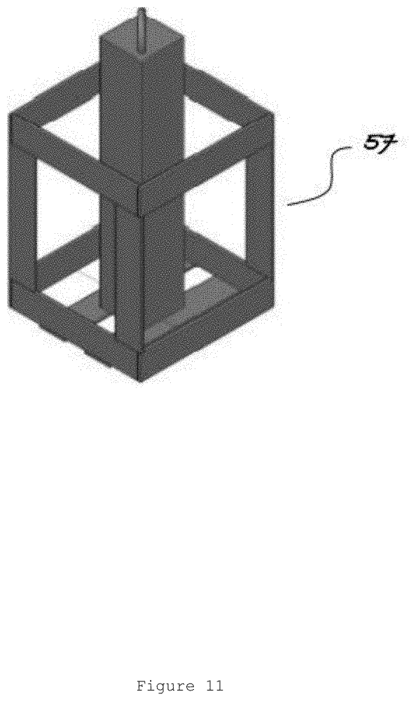

As shown in FIG. 6, the apparatus 10 comprises a counterweight system 52 comprising a counterweight 54, a pulley assembly 56 and a cord 58. The cord 58 has one end attached to the rotational means 14 and another end attached to the counterweight 54. The cord 58 extends from the rotational means 14 to the counterweight 54 and is supported on the pulley assembly 56. This arrangement permits and facilitates selectively displacing the rotational means 14 between the operative condition and the non-operative condition. As shown in FIGS. 10 and 11, the counterweight 54 comprises a counterweight 55 for receiving a weight 57.

Further, the pulley assembly 56 is mounted above and spaced apart from the table desk 24 of the frame 16. For this a post 60 extends from the table desk 24 having a free end 62 located distal from the table desk 24. The free end 62 is adapted to receive the pulley assembly 56 as shown in FIG. 6.

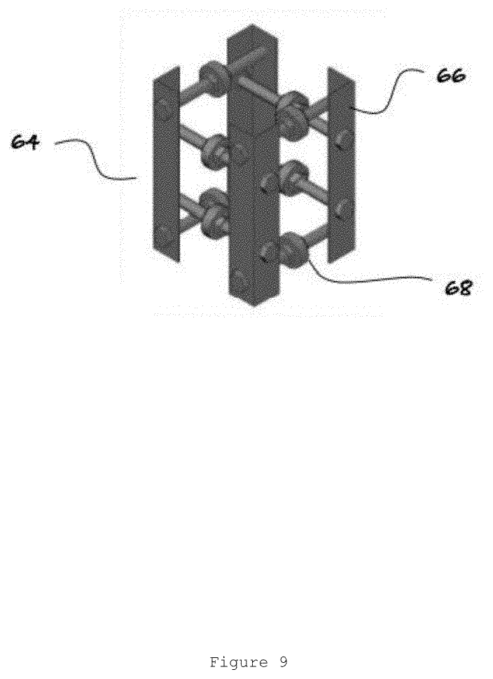

Furthermore, the cage 32 is slideable attached to the post 60 to permit the cage 32 selectively be displaced between the operative condition and the non-operative condition. For this, there is provided a travel frame set 64 (see FIG. 9) attached to the cage 32; the travel frame set 64 is adapted to receive the post 60 such that the travel frame set 64 may slide along the post 60. As shown in FIG. 9, the travel frame set 64 comprises an outer frame 66 having a wheel assembly 68 for abutment against the side walls of the post allowing a smooth movement of the travel frame set 64 along the post 60.

Moreover, the apparatus 10 comprises an electric system for electrically connecting the electric motor 36 to a power source. For this, the electric system comprises an insulated electric conductor 70 for delivering electric energy to the electric motor 36. The electric system also comprises controllers in the form an electric panel 72 and an electric control mounted in the handles(s) 51.

Referring now to FIGS. 12 to 18, FIGS. 12 to 18 show the particular arrangement of apparatus 10 in accordance with the present embodiment of the invention previously described in use for cleaning of a scaffolding jack 1.

As shown in FIG. 12, initially, with the cage 32 in the non-operative condition, the scaffolding jack 1 is mounted on the table desk 24 by inserting the scaffolding jack 1 in inverted condition in the slot 28 such that the threaded section 5 of scaffolding jack 1 is inserted in the fixing assembly 18 in order to fix the screw nut 4 impeding rotation of the screw nut 4 as was described earlier in connection with FIG. 4.

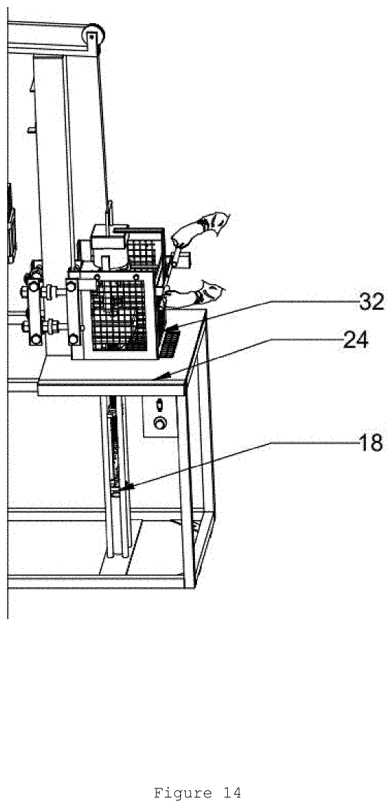

Subsequently, the cage 32 is moved by the operator (holding the handles 51 in her/his hands) into the operative condition as shown in FIG. 14. In this condition, the base plate 3 of the scaffolding jack 1 is contained within the coupling 44 of the spin housing 30; thus, the base plate 3 is operatively connected to the spin housing permitting rotation of the scaffolding jack 1 together with the threaded section 5 to be cleaned.

The operator, at this stage, using the handle(s) 51 activates the electric motor 36 of the spin housing 30 to rotate the threaded section 5 such that the screw nut 4 of the scaffolding jack 1 moves along the threaded section 5 for cleaning of the threaded section 5.

Activation of the electric motor 36 may comprises recurrently activating the source of rotational movement for providing rotational movement in the clockwise direction and recurrently activating the source of rotational movement for providing rotational movement in the counterclockwise direction. For this, the electric motor 36 is adapted to rotate the treaded section 5 in either a clockwise or counterclockwise rotation. This arrangement, is particularly useful because it allows to displace the screw nut 4 towards either one first direction along the threaded section or to another second direction (opposite to the first direction); thus, by selectively varying the direction of rotation (between clockwise and counter-clockwise) the screw nut 4 may be displaced a multitude of times from one end of the threaded section 5 to the other end of the threaded 5 permitting a throughout clean of the threaded section 5 due to repetitive moving of the crest of the inner thread of the screw nut 4 within the grooves of the outer thread of the threaded section 5.

Upon completion of the cleaning process, the operator may move the cage 32 into the non-operative condition and extract the scaffolding jack 1. Once the scaffolding jack 1 is extracted, the operator may rotate the screw nut 4 along the entire threaded section 5 to confirm whether the threaded section 5 of the scaffolding jack 1 has been properly cleaned. In case the operator notices that the screw nut 4 does not smoothly moves along the threaded section 5, the operator may further clean the scaffolding jack 1 using apparatus 10 as described above in relation to the method of operation of the apparatus 10

Modifications and variations as would be apparent to a skilled addressee are deemed to be within the scope of the present invention. For example, the particular arrangement shown in the figures, have been described in connecting with cleaning of a scaffolding jack 1; however, in alternative arrangements, threaded sections of other type of devices or fastening means (such as bolds used in the constructions industry) may be cleaned using the same method in accordance with the present embodiment of the invention.

Furthermore, the particular arrangement shown in the figures, move the screw nut 4 in a vertical direction. In alternative arrangements, the screw nut 4 may be moved sideways along the threaded section 5.

Moreover, the particular arrangement shown in the figures, have been described showing the threaded section 5 as being coupled to the spin housing 30 with the screw nut 4 in a non-rotational condition. In alternative arrangements, the screw nut 4 may be coupled to the spin housing 30 with the threaded section in a non-rotational condition. In these alternative arrangements, the fixing assembly 18 is adapted to impede rotational movement of the threaded section 5 comprising the base plate 3.

Further, it should be appreciated that the scope of the invention is not limited to the scope of the embodiments disclosed. These embodiments are intended for the purpose of exemplification only. Functionally equivalent products, formulations and methods are clearly within the scope of the invention as described herein.

Reference to positional descriptions, such as lower and upper, or inner and outer, are to be taken in context of the embodiments depicted in the figures, and are not to be taken as limiting the invention to the literal interpretation of the term but rather as would be understood by the skilled addressee.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprise”, “comprises”, “comprising”, “including”, and “having”, or variations thereof are inclusive and therefore specify the presence of stated features, integers, steps, operations, elements, and/or components, but do not preclude the presence or addition of one or more other features, integers, steps, operations, elements, components, and/or groups thereof.

Although terms such as first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first”, “second”, and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner”, “outer”, “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Throughout this specification, unless the context requires otherwise, the word “comprise” or variations such as “comprises” or “comprising”, will be understood to imply the inclusion of a stated integer or group of integers but not the exclusion of any other integer or group of integers.

1. A method for cleaning a threaded section having a thread groove adapted to receive a screw nut having an internal thread, the method comprising the steps of:
a. operatively connecting the threaded section to a source of rotational movement when the threaded section and the screw nut are threated onto each other;
b. fixing the screw nut such as to impede rotational movement of the screw nut and allowing movement of the screw nut along the threaded section when the threaded section is operatively connected to the source of rotational movement; and
c. activating the source of rotational movement for rotating the threaded section for displacing the screw nut towards a particular direction along the threaded section.

2. A method for cleaning a threaded section according to claim 1 further comprises the step of recurrently activating the source of rotational movement for providing rotational movement to the threaded section in the clockwise direction and recurrently activating the source of rotational movement for providing rotational movement to the threaded section in the counterclockwise direction for selectively displacing the screw nut towards a first direction and a second direction opposite to the first direction.

3. A method according to claim 1 wherein the threaded section is part of a scaffolding jack.

4. A method according to claim 3 wherein the screw nut comprises a screw nut of the scaffolding jack.

5. An apparatus for cleaning a threaded section having thread grooves adapted to receive a screw nut having an internal thread, the apparatus comprising a source of rotational movement, rotational means for operatively connecting the threaded section to the source of rotational movement, and fixing means for fixing the screw nut such as to impede rotational movement of the screw nut and allow movement of the screw nut along the threated section when the threaded section is operatively connected to the source of rotational movement.

6. An apparatus according to claim 5 wherein the rotational means is adapted to either provide clockwise rotational movement or counterclockwise rotational movement to the threaded section to move the screw nut along the threated section in a first direction or a second direction opposite to the first direction.

7. An apparatus according to claim 5 wherein the rotational means comprises a coupling adapted to releasably attach an end of the threaded section or at least a portion of the counterpart section.

8. An apparatus according to claim 5 wherein the fixing means comprises a frame and a fixing assembly attached to the frame, the fixing assembly being adapted to receive the screw nut to impede rotational movement of the screw nut and allow movement of the screw nut along the threaded section.

9. An apparatus according to claim 7 wherein a spin housing comprises the coupling being adapted to releasably attach the end of the threaded section.

10. An apparatus according to claim 9 wherein the rotational means comprises a cage for receiving the spin housing.

11. An apparatus according to claim 10 wherein the cage comprises handles extending from sides of the cage permitting operators to manipulate the cage.

12. An apparatus according to claim 9 wherein the spin housing comprises an electric motor having a shaft, and a spin section rotatably attached to the shaft.

13. An apparatus according to claim 12 wherein the spin section comprises a coupling with a cavity, the coupling being attached to the shaft to transfer rotational force generated by the electric motor to the coupling.

14. An apparatus according to claim 13 wherein the cavity is configured to match the outer profile of the end of the threaded section such that upon rotation of the spin section, the threaded section rotates with the spin section.

15. An apparatus according to claim 12 wherein at least one of the handles is operatively connected to an electric controller of an electric system delivering electric power to the electric motor for driving of the spin housing.

16. An apparatus according to claim 5 wherein the rotational means is adapted to be displaced between an upper position and a lower position.

17. An apparatus according to claim 5 wherein the apparatus further comprises a post attached to the fixing means and a travel frame set slideably attached to the post, the travel frame set being adapted to receive the rotational means.

18. An apparatus according to claim 5 wherein the apparatus further comprises a counterweight system having a counterweight, a pulley assembly and a cord supported by the pulley assembly, the rotational means being operatively connected to the counterweight system via the cord.

19. An apparatus according to claim 5 wherein the threaded section is part of a pole rod of a scaffolding jack having a base plate, and the screw nut comprises a screw nut of the scaffolding jack.

20. An apparatus according to claim 19 wherein the cavity is configured in order to operatively connect the base plate to the rotational means.

21. An apparatus according to claim 8 wherein the fixing means comprises a plurality of rods that extend from a lower portion of the frame towards an upper location of the frame, wherein the rods are arranged in a spaced apart relationship with respect to each other defining neighbouring rods and a plurality of spacing between the neighbouring rods.

22. An apparatus according to claim 21 wherein the spacing is adapted to receive wings of the screw nut for keeping the screw nut in a non-rotational condition and allow movement of the screw nut along the threated section.

23. An apparatus according to claim 19 wherein the fixing assembly comprises a hollow centre rod for receiving the end of the pole rod.

24. An apparatus according to claim 19 further comprising a table desk for mounting on the frame, the table desk comprising a surface having a slot for receiving the scaffolding jack in an inverted condition.

25. An apparatus according to claim 24 wherein the surface comprises a mesh surface.
